(19) United States
(12) Patent Application Publication
(10) Pub. No.: US 2017/0063560 A1
(43) Pub. Date: Mar. 2, 2017

(54) NETWORK CAMERA SYSTEM AND NETWORK CAMERA THEREOF

(71) Applicant: VIVOTEK INC., New Taipei City (TW)

(72) Inventor: Ming-Tsung Chen, New Taipei City (TW)

(21) Appl. No.: 15/235,112

(22) Filed: Aug. 12, 2016

(30) Foreign Application Priority Data
Aug. 25, 2015 (TW) 104127634

(51) Int. Cl. H04L 12/10; H04N 5/247; H04N 5/232; H04M 11/06; G06F 1/26

(52) U.S. Cl. CPC H04L 12/10; H04M 11/062; G06F 1/266; H04N 5/23241; H04N 5/247

(57) ABSTRACT

A network camera system includes a transmission device, a first network camera, and a first power device. The transmission device is used for providing a network power. The first power device is connected to the transmission device and the first network camera for receiving the network power so as to establish power transmission between the transmission device and the first network camera. The first power device includes a first battery and a first processing unit. The first battery is used for providing a first auxiliary power. The first processing unit is used for selectively transmitting the first auxiliary power to the first network camera as an operation power of the first network camera when determining the power transmission between the transmission device and the first network camera is interrupted.

### BACKGROUND OF THE INVENTION

1. Field of the Invention

The present invention relates to a network camera system and a network camera thereof, and more specifically, to a network camera system having a power device for providing an auxiliary power and a network camera thereof.

2. Description of the Prior Art

In general, a network camera utilizes a power cable to connect to an external power source for obtaining an external power, and utilizes a network cable to connect to a control terminal (e.g. a video surveillance host) for establishing network signal transmission between the control terminal and the network camera. However, when there are numerous network cameras needed to be set up, each network camera must be connected to the external power source and the control terminal respectively, so as to cause a complicated wiring process.

Via a PoE (Power over Ethernet) switch coupled to the external power source, the network camera could only utilize a network cable to obtain an operation power and establish network signal transmission between the control terminal and the network camera simultaneously, so as to simplify the wiring process of the network camera.

However, in the aforesaid design, the network camera could not obtain the operation power if power transmission between the network camera and the control terminal is interrupted (e.g. the network cable is cut by a thief or network failure occurs), so as to influence reliability and anti-theft effect of the network camera in image surveillance.

### SUMMARY OF THE INVENTION

The present invention provides a network camera system. The network camera system includes a transmission device, a first network camera, and a first power device. The transmission device is used for providing a network power. The first power device is connected to the transmission device and the first network camera for receiving the network power so as to establish power transmission between the transmission device and the first network camera. The first power device includes a first battery and a first processing unit. The first battery is used for providing a first auxiliary power. The first processing unit is used for selectively transmitting the first auxiliary power to the first network camera as an operation power of the first network camera when determining the power transmission between the transmission device and the first network camera is interrupted.

The present invention further provides a network camera performing power transmission with a transmission device to receive a network power. The network camera includes a power device connected to the transmission device for establishing power transmission between the transmission device and the network camera. The power device includes a battery and a processing unit. The battery is used for providing an auxiliary power. The processing unit is used for selectively transmitting the auxiliary power to the network camera as an operation power of the network camera when determining the power transmission between the transmission device and the network camera is interrupted.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a network camera system according to an embodiment of the present invention.

FIG. 2 is a functional block diagram of the network camera system in FIG. 1.

### DETAILED DESCRIPTION

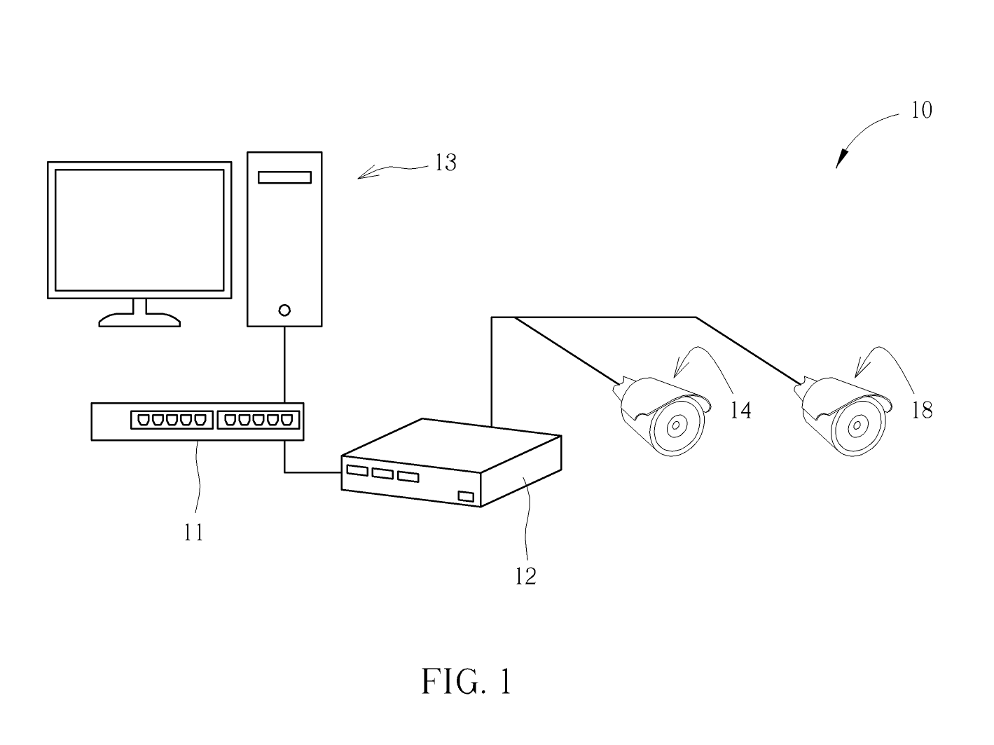

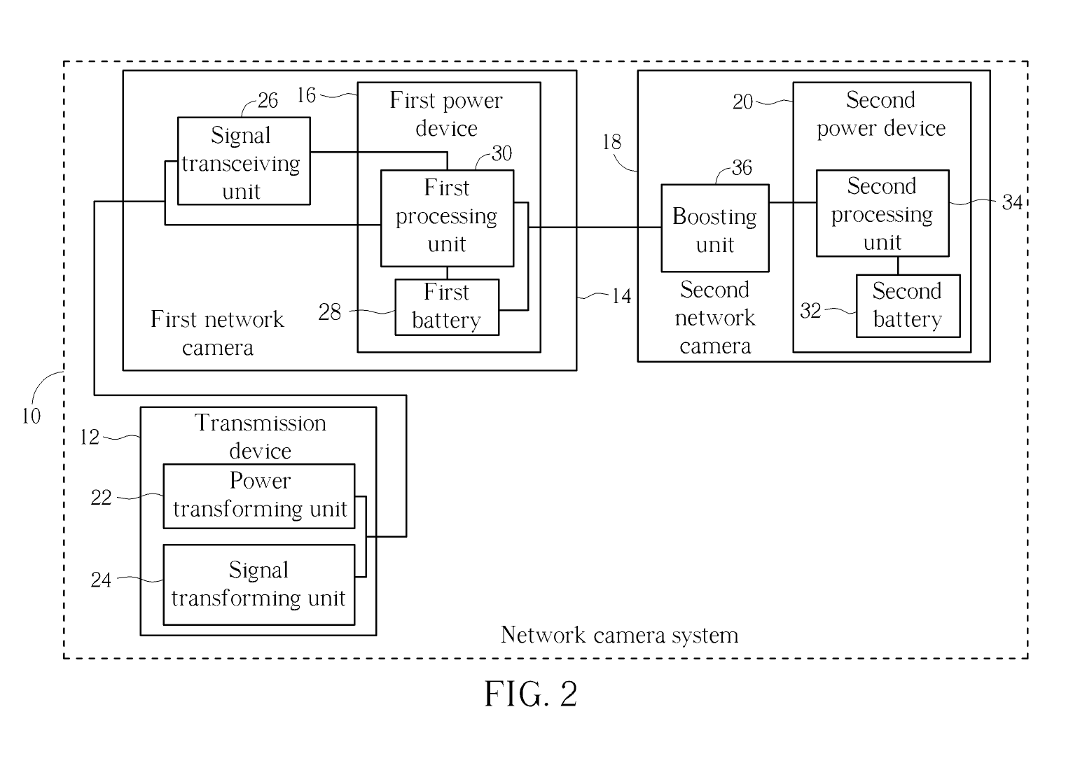

Please refer to FIG. 1 and FIG. 2. FIG. 1 is a diagram of a network camera system 10 according to an embodiment of the present invention. FIG. 2 is a functional block diagram of the network camera system 10 in FIG. 1. As shown in FIG. 1 and FIG. 2, the network camera system 10 includes a transmission device 12, a first network camera 14, a first power device 16, a second network camera 18, and a second power device 20. Amount of the first network camera 14 and the second network camera 18 is not limited to one as shown in FIG. 1, but could vary with the practical application of the network camera system 10. In practical application, the transmission device 12 could be connected to the first network camera 14 and a control terminal (e.g. a video surveillance host) and includes a power transforming unit 22 and a signal transforming unit 24. The power transforming unit 22 is used for transforming an external power transmitted from an external power source (e.g. the mains supply) into a network power. The signal transforming unit 24 is used for transforming an Ethernet signal into an xDSL (x Digital Subscriber Line) signal. The xDSL signal could be, but not limited thereto, an ADSL (Asymmetric DSL) signal, an SDSL (Symmetrical DSL) signal, an HDSL (High Data Rate DSL) signal, a VDSL (Very High Data Rate DSL) signal, or a VoDSL (Voice over DSL) signal.

To be more specific, if the transmission device 12 is connected to a control terminal 13 via a non-PoE switch 11 (as shown in FIG. 1), the signal transforming unit 24 could be used for transforming the Ethernet signal transmitted from the control terminal 13 via the non-PoE switch 11 into the xDSL signal, and the power transforming unit 22 could be used for transforming an external power in an alternating current mode transmitted from the external power source connected to the transmission device 12 into the network power in a direct current mode, so as to provide the network power to the first network camera 14 and establish network signal transmission between the first network camera 14 and the control terminal 13 for image surveillance management. On the other hand, if the transmission device 12 is connected to a control terminal via a PoE switch, the power transforming unit 22 could directly transmit the network power received from the PoE switch to the first network camera 14 without performing power transformation since the PoE switch has already transformed the external power in an alternating current mode into the network power in a direct current mode. Accordingly, the transmission device 12 just needs to utilize the signal transforming unit 24 to transform the Ethernet signal transmitted from the control terminal via the PoE switch into the xDSL signal. As for related description for the Ethernet network power supply principle and network signal transformation principle of the transmission device 12, it is commonly seen in the prior art and omitted herein.

Via the aforesaid design, due to the long distance transmission (400 m˜1000 m) capability of the xDSL signal, the network camera system 10 could utilize a network cable (e.g. Cat. 5 cable) suitable for xDSL signal transmission to insert into a corresponding connection port (e.g. RJ45 port) for establishing long distance transmission between the transmission device 12 and the first network camera 14. Accordingly, the present invention could greatly improve convenience and flexibility for setting up the network camera. To be noted, in another embodiment, the transmission device 12 could provide the network power to the first network camera 14 and establish network signal transmission between the first network camera 14 and the control terminal by utilizing a PoE switch to connect to the control terminal without performing the aforesaid network signal transforming process.

As shown in FIG. 1 and FIG. 2, the network camera system 10 could further include a signal transceiving unit 26. In this embodiment, the signal transceiving unit 26 and the first power device 16 are disposed in the first network camera 14 (but not limited thereto, meaning that the present invention could adopt the design that the signal transceiving unit 26 and the first power device 16 are coupled to the first network camera 14 in an external connection manner), and are connected to the transmission device 12 and the first network camera 14 for establishing power transmission between the transmission device 12 and the first network camera 14. To be more specific, the first power device 16 includes a first battery 28 and a first processing unit 30. The signal transceiving unit 26 could be used to transform the xDSL signal transmitted from the transmission device 12 back into the Ethernet signal for performing Ethernet signal transmission between the first power device 16 and the first network camera 14. Accordingly, the network camera system 10 could perform the related image processing operations (e.g. image transmission, image capturing or image capturing angle adjustment) of the first network camera 14 via the aforesaid signal transmission. The first battery 28 is used for providing auxiliary power, and the first processing unit 30 is used for selectively transmitting the auxiliary power to the first network camera 14 as an operation power of the first network camera 14 when determining power transmission between the transmission device 12 and the first network camera 14 is interrupted.

In such a manner, if the network power transmitted from the transmission device 12 is utilized as the operation power of the first network camera 14, the first processing unit 30 could shunt a shunt power from the network power transmitted from the transmission device 12 to the first network camera 14, and could utilize a remaining power to recharge the first battery 28. In another embodiment, the first network camera 14 could be connected to an external power source (not shown in figures) and could utilize an external power in an alternating current mode transmitted from the external power source as the operation power of the first network camera 14. To be noted, the external power in an alternating current mode transmitted from the external power source needs to be transformed in advance so as to be suitable for the first network camera 14.

On the other hand, if the power transmission between the first network camera 14 and the transmission device 12 is interrupted (e.g. the network cable is cut by a thief), the first processing unit 30 could transmit the auxiliary power provided by the first battery 28 to the first network camera 14 as the operation power of the first network camera 14 when determining the power transmission between the first network camera 14 and the transmission device 12 is interrupted. Accordingly, the first network camera 14 could continue performing the image surveillance operations. In such a manner, via the design that the first power device 16 could provide the auxiliary power to the first network camera 14 when the power transmission between the first network camera 14 and the transmission device 12 is interrupted, the present invention could efficiently solve the prior art problem that the network camera could not work properly if power transmission is interrupted, so as to greatly improve reliability and anti-theft effect of the network camera in image surveillance. It should be mentioned that the first processing unit 30 could control the first network camera 14 to save images captured by the first network camera 14 into a storage device (e.g. a memory card or a hard disk drive) of the first network camera 14 for a user to view if network signal transmission between the first network camera 14 and the transmission device 12 is also interrupted. Furthermore, if the network signal transmission between the first network camera 14 and the transmission device 12 is interrupted due to network failure but the power transmission is normal, the first processing unit 30 could control the first network camera 14 to save the captured images into the storage device of the first network camera 14, and could continue transmitting the network power transmitted from the transmission device 12 to the first network camera 14 as the operation power of the first network camera 14. On the contrary, if the power transmission between the first network camera 14 and the transmission device 12 is interrupted due to cable failure but the network signal transmission is normal, the first processing unit 30 could transmit the auxiliary power provided by the first battery 28 to the first network camera 14 as the operation power of the first network camera 14, and could continue transmitting the images captured by the first network camera 14 to the transmission device 12 for image surveillance management.

In practical application, the first processing unit 30 could be further used for detecting an electronic state of the first battery (e.g. whether the first battery 28 is over-charged or over-discharged, whether electrical connection of the first battery 28 is correct, whether the first battery 28 is overloaded, or whether a voltage of the first battery 28 is excessively low) and for reporting the electronic state to the first network camera 14 or the control terminal 13 via the transmission device 12, so that a user could clearly know the condition of the first battery 28 and perform the appropriate operation (e.g. battery replacement). Moreover, the first processing unit 30 could be further used for transmitting a remaining power after the network power passes through the first network camera 14 to the first battery 28 for recharging the first battery 28, so as to improve the network power utilization efficiency of the network camera system 10.

The second network camera 18 and the second power device 20 could have the same designs with the first network camera 14 and the first power device 16, and the related description could be reasoned by analogy according to the aforesaid embodiment. That is, as shown in FIG. 1 and FIG. 2, the second network camera 18 is connected to the first network camera 14 in a network cable connection manner. In this embodiment, the second power device 20 is disposed in the second network camera 18 (but not limited thereto, meaning that the present invention could adopt the design that the second power device 20 is coupled to the second network camera 18 in an external connection manner), and is connected to the first network camera 14 and the second network camera 18 for establishing power transmission between the first network camera 14 and the second network camera 18. To be more specific, the second power device 20 includes a second battery 32 and a second processing unit 34. The second battery 32 is used for providing auxiliary power, and the second processing unit 34 is used for selectively transmitting the auxiliary power provided by the second battery 32 or a remaining auxiliary power after the auxiliary power provided by the first power device 16 passes through the first network camera 14 to the second network camera 18 as an operation power of the second network camera 18 when determining the power transmission between the transmission device 12 and the network camera 14 is interrupted. The second processing unit 34 is further used for selectively transmitting the auxiliary power provided by the second battery 32 to the second network camera 18 when determining power transmission between the first power device 16 and the second power device 20 is interrupted.

In such a manner, if the network power transmitted from the transmission device 12 is utilized as the operation power of the second network camera 18, the first processing unit 30 could provide a remaining power after the network power passes through the first network camera 14 to the second network camera 18 after the first processing unit 30 shunts a shunt power from the network power transmitted from the transmission device 12 to the first network camera 14. Accordingly, the second network camera 18 could utilize the remaining power to perform the related image surveillance operations. To be noted, as shown in FIG. 1, since the second network camera 18 could be regarded as a terminal network camera in this embodiment, the second processing unit 34 could directly transmit all of the aforesaid remaining power to the second network camera 18 without performing the power shunting operation, and could perform Ethernet signal transmission between the first network camera 14 and the second network camera 18. In another embodiment, the second network camera 18 could be connected to an external power source (not shown in figures) and utilize an external power in an alternating current mode transmitted from the external power source as the operation power of the second network camera 18. As for other derived embodiments for power selection (e.g. the first network camera 14 utilizes the external power in an alternating current mode transmitted from the external power source and the second network camera 18 utilizes the network power transmitted from the transmission device 12), the related description could be reasoned by analogy and omitted herein.

On the other hand, if power transmission between the second network camera 18 and the transmission device 12 is interrupted (e.g. the network cable is cut by a thief), the second processing unit 34 could perform the auxiliary power transmission when determining the power transmission between the transmission device 12 and the first network camera 14 or the power transmission between the first power device 16 and the second power device 20 is interrupted. To be more specific, the second processing unit 34 could transmit the auxiliary power provided by the second power device 20 to the second network camera 18 when determining the power transmission between the transmission device 12 and the first network camera 14 is interrupted. Accordingly, the second network camera 18 could continue performing the image surveillance operations. To be noted, the second processing unit 34 could transmit the remaining auxiliary power after the auxiliary power provided by the first power device 16 passes through the first network camera 14 to the second network camera 18. In practical application, as shown in FIG. 2, the second network camera 18 could further include a boosting unit 36. The boosting unit 36 is coupled to the first network camera 14 for boosting the remaining auxiliary power after the auxiliary power provided by the first power device 16 passes through the first network camera 14 and then transmitting the remaining auxiliary power to the second network camera 18, so as to solve the voltage drop problem. Accordingly, the second network camera 18 could receive the remaining auxiliary power with a sufficient voltage and work properly.

Furthermore, if the second processing unit 34 determines that the power transmission between the first power device 16 and the second power device 20 is interrupted, the second processing unit 34 could transmit the auxiliary power provided by the second power device 20 to the second network camera 18 so that the second network camera 18 could continue performing the image surveillance operations. As for the related description for the condition that network signal transmission between transmission device 12 and the second network camera 18 is also interrupted, the condition that network signal transmission among the second network camera 18, the transmission device 12 and the first network camera 14 is interrupted due to network failure but power transmission is normal, or the condition that power transmission among the second network camera 18, the transmission device 12 and the first network camera 14 is interrupted due to cable failure but the network signal transmission is normal, it could be reasoned by analogy according to the aforesaid embodiments and omitted herein.

It should be mentioned that the configuration of the first network camera 14, the first power device 16 and the second network camera 18 is not limited to the aforesaid embodiments. For example, in another embodiment, the second network camera 18 could be directly connected to the first power device 16. In this embodiment, the first processing unit 30 could be used for selectively transmitting the remaining auxiliary power after the auxiliary power provided by the first power device 16 passed through the first network camera 14 to the second network camera 18. Furthermore, in another embodiment, if the first network camera 14 is the only one network camera in the network camera system 10, the first network camera 14 could directly utilize the network power as the operation power without performing the power shunting operation. Moreover, amount of network camera in serial connection is not limited to two as mentioned in the aforesaid embodiments. In other words, in the condition that the connection length of the network cable does not exceed the allowable network signal transmission distance and power needed for operations of the network camera could be obtained from the aforesaid power shunting method or the external power source, the amount of network camera in serial connection could vary with the practical application of the network camera system 10.

In summary, the present invention could utilize the power device to provide the auxiliary power to the network camera when power transmission between the transmission device and the network camera is interrupted, so as to ensure that the network camera could keep working properly. In such a manner, the present invention could efficiently solve the prior art problem that the network camera could not work properly if power transmission is interrupted, so as to greatly improve reliability and anti-theft effect of the network camera in image surveillance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network camera system comprising:
a transmission device for providing a network power;
a first network camera; and
a first power device connected to the transmission device and the first network camera for receiving the network power so as to establish power transmission between the transmission device and the first network camera, the first power device comprising:
a first battery for providing a first auxiliary power; and
a first processing unit for selectively transmitting the first auxiliary power to the first network camera as an operation power of the first network camera when determining the power transmission between the transmission device and the first network camera is interrupted.

2. The network camera system of claim 1, wherein the transmission device comprises a power transforming unit and a signal transforming unit, the power transforming unit is used for transforming power transmitted from an external power source into the network power, the signal transforming unit is used for transforming an Ethernet signal into an xDSL (x Digital Subscriber Line) signal, the network camera system comprises a signal transceiving unit, the signal transceiving unit is connected to the first processing unit and connected to the transmission device in a network cable connection manner, the signal transceiving unit is used for transforming the xDSL signal back into the Ethernet signal so as to perform Ethernet signal transmission between the transmission device and the first network camera.

3. The network camera system of claim 2, wherein the xDSL signal is an ADSL (Asymmetric DSL) signal, an SDSL (Symmetrical DSL) signal, an HDSL (High Data Rate DSL) signal, a VDSL (Very High Data Rate DSL) signal, or a VoDSL (Voice over DSL) signal.

4. The network camera system of claim 1, wherein the first processing unit selectively shunts a shunt power from the network power transmitted from the transmission device to the first network camera as the operation power of the first network camera.

5. The network camera system of claim 1 further comprising:
a second network camera connected to the first network camera in a network cable connection manner, for selectively receiving a remaining power after the network power passes through the first network camera as an operation power of the second network camera.

6. The network camera system of claim 5, wherein the network camera system further comprises a second power device connected to the first network camera and the second network camera, and the second power device comprises:
a second battery for providing a second auxiliary power; and
a second processing unit for selectively transmitting the second auxiliary power or a remaining auxiliary power after the first auxiliary power passes through the first network camera to the second network camera as the operation power of the second network camera when determining the power transmission between the transmission device and the first network camera is interrupted and for selectively transmitting the second auxiliary power to the second network camera as the operation power of the second network camera when determining power transmission between the first power device and the second power device is interrupted.

7. The network camera system of claim 5, wherein the second network camera has a boosting unit coupled to the first network camera for boosting a remaining auxiliary power after the first auxiliary power passes through the first network camera and then transmitting the remaining auxiliary power to the second network camera, and the second network camera is used for selectively receiving the remaining auxiliary power as the operation power of the second network camera when determining the power transmission between the transmission device and the first network camera is interrupted.

8. The network camera system of claim 1 further comprising:
a second network camera connected to the first power device, the first processing unit being used for selectively transmitting a remaining auxiliary power after the first auxiliary power passes through the first network camera to the second network camera as an operation power of the second network camera when determining the power transmission between the transmission device and the first network camera is interrupted.

9. The network camera system of claim 1, wherein the first processing unit is used for detecting an electronic state of the first battery and for reporting the electronic state to the first network camera or the transmission device.

10. The network camera system of claim 1, wherein the first processing unit is used for selectively transmitting a remaining power after the network power passes through the first network camera to the first battery to recharge the first battery.

11. A network camera performing power transmission with a transmission device to receive a network power, the network camera comprising:
a power device connected to the transmission device for establishing power transmission between the transmission device and the network camera, the power device comprising:
a battery for providing an auxiliary power; and
a processing unit for selectively transmitting the auxiliary power to the network camera as an operation power of the network camera when determining the power transmission between the transmission device and the network camera is interrupted.

12. The network camera of claim 11, wherein the transmission device is used for transforming power transmitted from an external power source into the network power and transforming an Ethernet signal into an xDSL signal, the transmission device is coupled to the network camera in a network cable connection manner for performing transmission of the network power and the xDSL signal, the network camera further comprises a signal transceiving unit, the signal transceiving unit is connected to the processing unit for transforming the xDSL signal back into the Ethernet signal so as to perform Ethernet signal transmission between the signal transceiving unit and the power device, and the processing unit is used for selectively transmit the network power to the network camera as the operation power of the network camera.

13. The network camera of claim 12, wherein the xDSL signal is an ADSL signal, an SDSL signal, an HDSL signal, a VDSL signal, or a VoDSL signal.

14. The network camera of claim 11, wherein the processing unit selectively shunts a shunt power from the network power transmitted from the transmission device to the network camera as the operation power of the network camera.

15. The network camera of claim 14, wherein the network camera is coupled to another network camera in a network cable connection manner, and the processing unit is used for transmitting a remaining power after the network power passes through the network camera to the another network camera and for performing network signal transmission between the network camera and the another network camera.

16. The network camera of claim 11, wherein the processing unit is used for detecting an electronic state of the battery and for reporting the electronic state to the network camera or the transmission device.

17. The network camera of claim 11, wherein the processing unit is used for selectively transmitting a remaining power after the network power passes through the network camera to the battery to recharge the battery.
